(19) United States
(12) Patent Application Publication
(10) Pub. No.: US 2026/0210708 A1
(43) Pub. Date: Jul. 23, 2026

(54) METHOD FOR DETECTING SCALE INSIDE CONDUIT USING PROPERTIES OF TUBE WAVES

(71) Applicant: Seismos, Inc., Austin, TX (US)

(72) Inventors: Daniel Moos, Palo Alto, CA (US); Saeed Rahimi-Aghdam, Austin, TX (US); Eric M. Dunham, Stanford, CA (US)

(21) Appl. No.: 19/434,834

(22) Filed: Dec. 29, 2025

Related U.S. Application Data
(63) Continuation of application No. PCT/US2024/034668, filed on Jun. 20, 2024.
(60) Provisional application No. 63/511,565, filed on Jun. 30, 2023.

(51) Int. Cl. G01B 21/14; G01N 7/00

(52) U.S. Cl. CPC G01B 21/14; G01N 7/00

(57) ABSTRACT

A method for characterizing fluid flow properties in a pipe includes measuring pressure of a fluid flowing in the pipe. A pressure of the fluid in the pipe is changed from a first pressure to a second pressure. The changing pressure is performed so as to induce tube waves in the pipe. Location along the pipe is determined of at least one of (i) magnitude of changes in internal diameter in the pipe, or (ii) fluid flow friction factor of the pipe from tube wave induced events in the measured pressure. In some embodiments, the changing pressure is performed by changing a flow rate of fluid in the pipe.

### CROSS REFERENCE TO RELATED APPLICATIONS

Continuation of International Application No. PCT/US2024/034668 filed on Jun. 20, 2024. Priority is claimed from U.S. Provisional Application No. 63/511,565 filed on Jun. 30, 2023. Both the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of evaluating flow conditions inside fluid filled pipes or conduits, such as subsurface wells or pipelines (buried or exposed). More particularly, the disclosure relates to methods for using properties of tube waves induced in fluid within such conduits in order to evaluate the fluid flow properties of conduits, e.g., locating buildup of scale or other diameter reducing materials and estimating reduction in diameter caused by such materials, or increase frictional drag on fluid flow by reason of increased pipe surface roughness caused by corrosion.

In wells drilled through subsurface formations for extracting hydrocarbons, it is frequently the case that conduit in such wells, e.g., casing, liner or tubing, may have accumulations of materials referred to as scale. In such hydrocarbon producing wells, primary scale types include mineral scale from produced water that frequently accompanies hydrocarbon production, asphaltenes and other organic types of scale, and diameter reducing accumulations of gas hydrates. Places within such wells susceptible to scale accumulation include where the well conduit penetrates the bottom of a body of water, at distal ends of the well, near the surface expression of the well and in surface collection and piping facilities. Scale is known to accumulate as well in other conduits such as sewers, gas pipelines, water pipes, food preparation conduits or other pipes carrying slurries.

Deposition of scale in conduits occurs, among other reasons, due to chemical disequilibrium that is enhanced by pressure or temperature changes or by mixing different fluid streams. Thus, scale accumulation can be associated with valves, pipe connections, entry/exit from outside to inside of a pipe or well, gathering points of multiple fluids, among other devices.

Scale accumulation reduces the internal diameter, and thus flow area, of the affected conduit. Reduced flow area results in larger pressure drop between the outlet and the inlet of the affected conduit. In fluid producing subsurface wells, inlet pressure is fixed by reservoir formation conditions, and outlet pressure cannot be less than zero; thus, scale can prevent being able to produce fluids from subsurface reservoir formations.

In wells used to inject fluid into subsurface formations, e.g., for water flooding or other secondary/tertiary recovery methods, or for waste fluid disposal, scale can make it impossible to obtain required fluid injection rates even if the reservoir pressure does not increase, as a result of reduced pipe internal diameter leading to excessive pressure drop along the well. Pressures needed to sustain injection rate may therefore exceed pressure limitations of surface equipment used for injecting fluid.

In addition, a well conduit may have increased corrosion due to chemical incompatibility between scale and the conduit material; scale buildup can prevent moving parts from functioning correctly, e.g., a rapid-closure valve may be stuck open; and changes in conduit internal diameter can affect mixing rates of multiple fluids. Corrosion can also increase surface roughness of the inner wall of a pipe or conduit, thereby reducing flow capacity or requiring additional energy to move fluid through the pipe or conduit.

Methods and apparatus for detecting scale and corrosion and characterizing its effects on a conduit known in the art include the following:

Running a measurement or imaging device into the well or conduit, e.g., a caliper, a pig, or an acoustic imager. Limitations of such methods include difficulty of accessing the well and running the device (with accompanying risk of loss or the device becoming stuck in the well) and the need to stop flow through (shut in of) the well or conduit, among other limitations.

Monitoring pressure drop (ΔP) between two known points at known flow rates (Q) and computing ΔP/Q. Limitations of the foregoing are the need to measure pressure at separated positions, and to measure the flow rate, Q. For inaccessible conduits this requires installing the system interior to the conduit prior to installing the conduit for use.

Conducting well testing and observing very early time variations in well conditions after shut in. Limitations of such methods are the need to shut in the well or pipeline. Restarting flow can cause degradation in the conduit and its associated equipment. The foregoing is in addition to lost production time and its associated financial cost.

Thus, there is a need for improved techniques and devices to detect and characterize fluid flow characteristics in wells and conduits, preferably without shutting them in.

### SUMMARY

One aspect of the present disclosure is a method for determining fluid flow properties of a pipe or conduit. A method according to this aspect includes measuring pressure of a fluid flowing in the pipe. A pressure of the fluid in the pipe is changed from a first pressure to a second pressure. The changing pressure is performed so as to induce tube waves in the pipe. Location along the pipe is determined of at least one of (i) magnitude of changes in internal diameter in the pipe, or (ii) fluid flow friction factor of the pipe from tube wave induced events in the measured pressure.

A non-transitory computer readable medium according to another aspect of the disclosure comprises logic operable to cause a programmable computer to perform the above actions and in certain embodiments, the actions shown below.

In some embodiments, the pressure change is caused by changing a flow rate of fluid in the pipe from a first flow rate to a second flow rate

In some embodiments, the magnitude is determined from a rate of change of the measured pressure with respect to time between a first pressure change caused by the flow rate change and a second pressure change caused by a tube wave reflection in the pipe.

In some embodiments, the location is determined from measurements of a time between performing the flow rate change and detection of a tube wave reflection caused by a change in the internal diameter.

In some embodiments, the time between performing the flow rate change and detection of the tube wave reflection caused by a change in the internal diameter is determined by determining an elapsed time between successive peak or trough values in a time derivative of the measured pressure.

Some embodiments further comprise, at at least one selected time, repeating the measuring pressure of the flowing fluid, repeating changing the rate from the first rate to the second rate and determining location along the pipe and magnitude to characterize changes in the location and magnitude with respect to time.

In some embodiments, the determining location along the pipe of and at least one of (i) magnitude of changes in internal diameter in the pipe, or (ii) fluid flow friction factor of the pipe from tube wave induced events comprises inversion processing the measured pressure.

In some embodiments, the inversion processing is performed with respect to a time derivative of the measured pressure.

In some embodiments, the pipe diameter and friction factor are determined from precalculated lookup tables of pressure change and pressure decay after the pressure drop generated using known values of flow rate and flow rate change.

In some embodiments, the precalculated lookup tables comprise parameter bands related to uncertainty in determining pressure decay and pressure change.

Other aspects and possible advantages will be apparent from the description and claims that follow.

### BRIEF DESCRIPTION OF THE DRAWINGS

FIG. 1 shows equipment that may be used to induce tube waves in a conduit such as a subsurface well or a pipeline (shown buried but may be exposed).

FIG. 2 shows a graph of fluid pressure in a conduit when flow rate is changed from a first value to a second value, wherein tube wave events are detectable in the fluid pressure.

FIG. 3 shows the graph of FIG. 2 with explanation of pressure response within specific parts of the graph.

FIG. 4 shows a graph similar to FIG. 3, in which part of the conduit has reduced diameter at one end due to scale buildup.

FIG. 4A shows a cross section of the interior of the conduit that results in the pressure graph in FIG. 4.

FIG. 5 shows a graph similar to FIG. 4, wherein a reduced diameter portion of the conduit is intermediate the ends of the conduit.

FIG. 5A shows a cross section of the interior of the conduit that results in the pressure graph in FIG. 5.

FIG. 6 shows a pressure graph for pressure measurements sampled at a low rate for a particular example of scale buildup on the interior of a conduit.

FIG. 7 shows a pressure graph for pressure measurements sampled at a higher rate than in the graph of FIG. 6, wherein specific features in the pressure may be identified.

FIG. 8 shows a flow chart of an example implementation of an inversion process to determine pipe diameter and friction factor.

FIGS. 9A, 9B and 9C show pressure and pressure time derivative with respect to time referenced to a flow/pressure change in a pipe responsive to a first segment of the pipe.

FIGS. 10A, 10B and 10C show pressure and pressure time derivative with respect to time referenced to a flow/pressure change in a pipe responsive to a second segment of the pipe.

FIGS. 11A, 11B and 11C show pressure and pressure time derivative with respect to time referenced to a flow/pressure change in a pipe responsive to the second segment of the pipe, wherein a length of the second segment initially selected is in error.

FIGS. 12A and 12B show nomograms usable to determine pipe diameter and friction factor from precalculated values of pressure drop and pressure decay after the pressure drop under known conditions.

FIGS. 13A, 13B and 13C show nomograms corresponding to FIGS. 12A and 12B wherein there are uncertainties in determining pressure drop and pressure decay in the pipe.

FIGS. 14A through 14C show using time derivative of measured pressure to calculate flow properties of a pipe in a segment of the pipe following a change in the properties.

FIG. 15 shows a computer system that may be used to implement a method according to the present disclosure.

### DETAILED DESCRIPTION

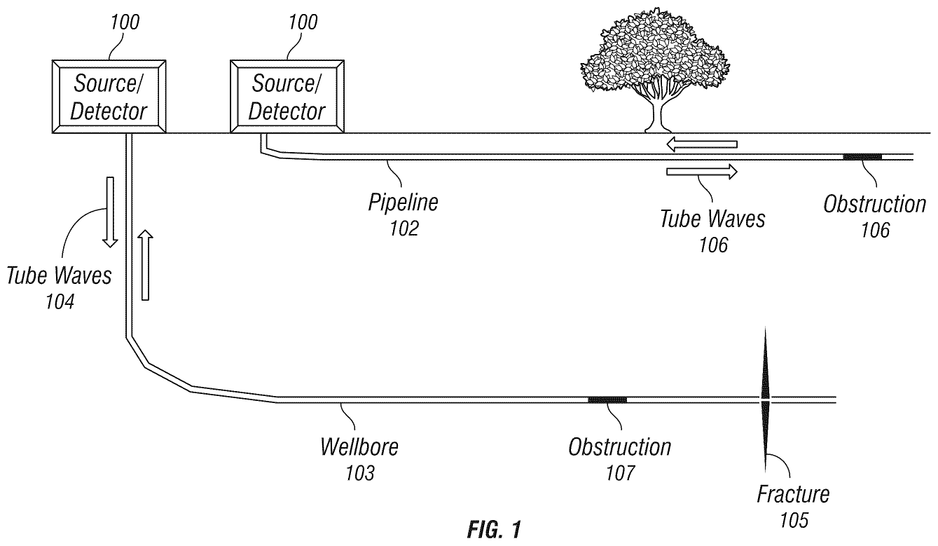

FIG. 1 shows example arrangements of equipment that may be used in a method according to the present disclosure. A subsurface well or wellbore 103 (used interchangeably herein) may be drilled through one or more rock formations 108 for recovery of fluid to the surface or for disposal of fluid pumped from the surface. Surface equipment shown generally at 100 may comprise flow controls (not shown separately) providing the capability of changing fluid flow rate into the formation 108 or out of the well 103 to the surface. Such controls (not shown) may include, for example, pumps, valves and the like. It is only necessary for such controls to be able to change the flow rate rapidly enough and to such an amount necessary to induce tube waves 104 to propagate in the fluid in the well 103, wherein such tube waves may be detected in measurements of fluid pressure in the well 103. The well 103 may have inserted therein a conduit 105 such a liner, casing or tubing, which may be referred to as a “conduit” or “pipe” for convenience herein.

The equipment 100 may comprise one or more pressure sensors and recording devices (not shown separately) to make a record with respect to time of fluid pressure in the well 103. Such record may be used in accordance with the present disclosure to locate within the well 103 and to characterize one or more obstructions 106, such as may be caused by buildup of scale or increased surface roughness so as to reduce the internal diameter and thereby the effective flow area of the well 103, and/or change the friction factor for flowing fluid of the internal surface of the pipe or conduit 105. Recording devices (not shown separately) in the equipment 100 may be disposed in an entirely different location and need not be an integral part of the equipment 100.

Correspondingly, in a conduit or pipe used as a pipeline 102, there may be at one or more locations along the pipeline 102 equipment 100 that performs similar functions as equipment explained above as used on a well 103. The pipeline equipment 100 may have flow controls enabling inducing tube waves in fluid in the pipeline 102 and pressure sensor(s) and recording devices. Record of pressure with respect to time may be used in accordance with the present disclosure to enable locating and characterizing one or more flow obstructions 106 in the pipeline 102. In the present disclosure, such flow obstructions may be internal diameter reduction within the conduit resulting from accumulation of scale.

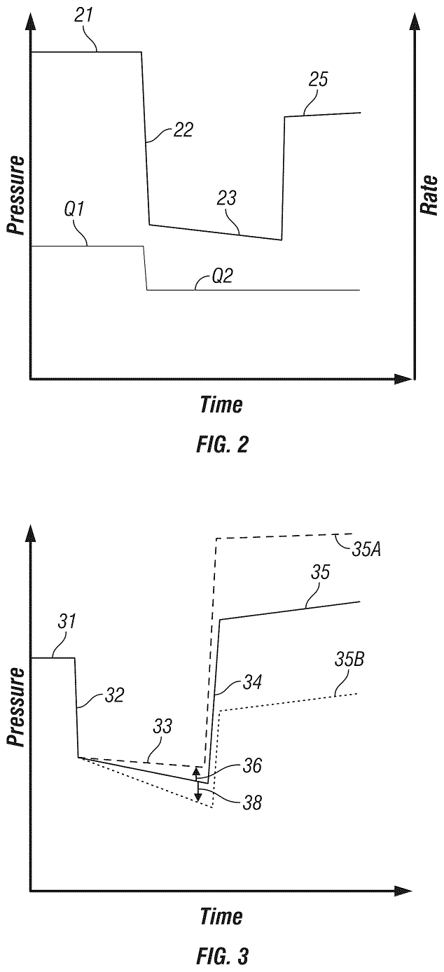

FIG. 2 shows a graph of fluid pressure in a conduit (e.g., a well or pipeline as explained with reference to FIG. 1) having fluid flowing therein, before and after a change in flow rate of the fluid through the conduit. As explained above, the fluid flow rate is changed sufficiently quickly so as to induce tube waves (e.g., as a result of water hammer) to propagate in the conduit. At 21, the fluid is flowing at a first rate Q1 until the abrupt flow rate change at 22. The flow rate in this example is reduced from the first rate Q1 to a second, lower rate Q2. The flow rate could instead be increased consistent with the scope of the present disclosure. At 22, fluid pressure measured in the conduit (e.g., at a surface end as explained with reference to FIG. 1 when the conduit is in a well) drops rapidly in response to the reduction in flow rate. Because of pipe friction effects on fluid flow and on propagation of tube waves in the conduit, at 23, the measured pressure continues to drop for a certain period of time after the change in flow rate. Such pressure drop may be referred to for convenience herein as “pressure decay.” The rate at which the pressure decreases with respect to time is related to the pipe friction effects on fluid flow and tube wave propagation. When the tube waves reach a place in the conduit where a reflection may be generated, e.g., the formation as shown in the well of FIG. 1, a change in pipe fluid flow properties such as a change in internal diameter, or an end of the pipeline shown in FIG. 1, the reflected tube waves eventually reach the pressure sensor and an abrupt pressure increase may be observed as shown at 24, until the pressure stabilizes at a final value at 25. Pipe friction causes a slight pressure increase with respect to time in the pressure measurement segment at 25. The present description is made in terms of decreasing flow rate and accompanying drop in pressure to generate tube waves in the well, pipeline or conduit. It is equally within the scope of the present disclosure to increase flow rate accompanied by an increase in pressure to generate tube waves in order to perform a method according to the present disclosure.

Further, while example embodiments of a method according to this disclosure are described in terms of changing a flow rate of fluid in the pipe or conduit to induce pressure changes, it is equally within the scope of the present disclosure to induce a pressure change in the pipe by other means. As an example of such other means, in a well or pipeline, there may be flow controls downstream of the pressure sensor (measurement point), e.g., valves. Downstream in this context means further along the direction of fluid flow from a reference point. When such valves are opened or closed, pressure in the well or pipeline will change correspondingly without changing the rate at which fluid enters the pipe upstream of the pressure sensor. However implemented, whether by changing flow rate or pressure, it is only necessary to cause the pressure in the well or pipe to change in a way that induces tube waves in the well or pipe.

For purposes of determining a property of the well or pipe at a location or position (detection point) disposed at a distance dX from the pressure measurement point (i.e., the location of the pressure sensor) it is sufficient to measure pressure for a time interval after the pressure drop (caused by change in flow rate) sufficient to allow the property at the detection point to affect the pressure at the measurement point. That time interval dT after the pressure pulse passes the measurement point, reflects from the detection point and returns to the measurement point can be computed from the known distance between the detection point and the measurement point, and the known tube wave velocity, C_{T} by the expression:

$$dT = 2 dX / {C}_{T}$$

At times before dT, objects located in the well or pipeline at a distance beyond position dX=dT*C_{T}/2 do not affect the pressure measurements, because the pressure (tube) wave has to travel to the detection point and back to the pressure sensor (measurement point) location; the pressure (tube) wave cannot travel faster than the tube wave propagation speed.

The pressure graph in FIG. 3 shows similar features to the graph in FIG. 2, and illustrates the effect of pipe friction on the measured pressure in the time between the change in fluid flow rate and detection of the reflected tube waves in the measured pressure. At 31, fluid is flowing in the conduit at the first rate Q1. At 32, the flow rate is changed sufficiently quickly and in sufficient amount to induce tube waves in the conduit. At 33, pressure in the conduit continues to drop because of the effect of pipe friction. Pressure decrease in the conduit is related to the following expression:

$$\frac{Δ {p}_{pipe}}{{L}_{pipe}} = \frac{ρ f}{{π}^{2} {D}^{5}} {Q}^{2}$$

in which ρ=density; f=pipe friction coefficient; D=pipe diameter; Q=fluid flow rate; Lₚᵢₚₑ=pipe length.

Slope of the pressure in the time segment at 33 (between the flow rate change and the return of a reflected tube wave) is related to:

$$\frac{ρ f}{{π}^{2} {D}^{5}} {Q}^{2}$$

If the pipe has a smaller diameter or a larger wellbore friction coefficient (e.g., such as may be caused by surface roughness), as shown at 38, the slope of the pressure curve at 33 (during pressure decay) will be larger. Conversely, larger pipe diameter or lower friction coefficient will result in a lower slope, at 36 of the pressure curve using the interval at 33.

Pipe friction effects after detection of the reflected tube wave (at 34) shown in the segment of the pressure graph at 35 may be characterized by greater slope at 35B when the pipe diameter is smaller, the friction coefficient is greater or both. Converse diameter and friction effects may be observed in the pressure curve in the segment at 35A.

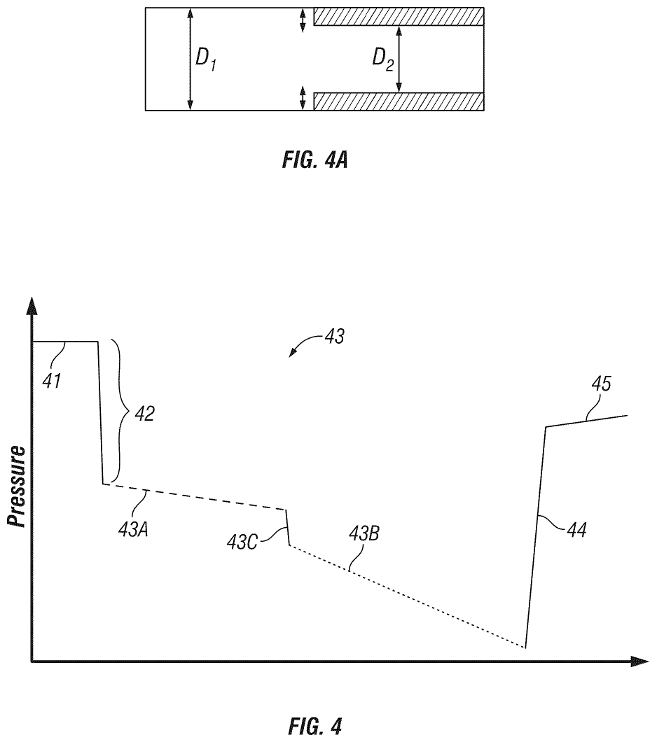

FIG. 4A shows a cross section of a segment of a pipe or well in which internal diameter is reduced, e.g., by buildup of scale. The illustrated segment of pipe has such diameter reduction from the nominal pipe internal diameter D₁ to a smaller internal diameter D₂ at a position toward one end of the pipe. Expected pressure measurements in such pipe or well may be observed in FIG. 4. At 41, fluid flows in the pipe at a first flow rate Q1, wherein the pressure is shown on the graph. At 42, the flow rate is changed in this example to a lower rate Q2 to induce tube waves in the pipe. The immediate drop in pressure Δₚ_{ᵢₙₛₜ} in the pipe is related by the following expression:

$$Δ {p}_{inst} = \frac{ρ {C}_{T}}{{A}_{1}} Δ Q$$

in which C_{T} is the propagation speed of the tube waves in the fluid in the pipe, ρ is the fluid density, A₁ is the cross-sectional area of the larger diameter (e.g., unaffected by scale) part of the pipe and ΔQ is the change in fluid flow rate. It will be appreciated that in order to determine various fluid friction properties of the pipe or conduit, it is necessary to obtain reasonably accurate values of the propagation speed C_{T} and density ρ of the fluid. The above equation can be re-written as:

$${C}_{T} = \frac{Δ {p}_{inst} {A}_{1}}{Δ Q ρ}$$

allowing calculation of C_{T} from a change in flow rate ΔQ which may be, for example, directly measured using a flow meter, and a change in pressure Δₚ_{ᵢₙₛₜ}. Density may be measured of a fluid sample, or the density may be known a priori based on fluid composition; or, C_{T} may be derived without knowing density from travel time of reflected pressure wave events to known features in the well or pipe, using Ct=2*DX/TWT, where DX is the distance between the measurement point and the feature (the reflection point), and TWT is the two-way travel time of the tube wave between those two locations. The latter method combined with the former may enable simultaneous determination of fluid density and tube wave propagation speed.

The amount of time between the change in flow rate and detection of reflected tube waves may have pressure response corresponding to the change in internal diameter shown in FIG. 4A. At 43A, pressure after the flow rate change continues to decrease because of pipe friction effects in the larger diameter portion of the pipe (D₁ in FIG. 4A), e.g., a part of the pipe unaffected by scale buildup. Rate of pressure change at 43A is related to:

$$\frac{ρ {f}_{1}}{{D}_{1}^{5}}$$

in which f₁ is the friction coefficient in the larger diameter (D₁) portion of the pipe. At 43C, an abrupt drop in pressure results from the tube wave acting on the change in internal diameter of the pipe. As shown in FIG. 4A, this may occur, for example, at the onset of scale buildup in the pipe. The magnitude of the pressure drop at 43C is related to the change in internal diameter of the pipe and the change in flow rate by the following expression:

$$Δ p = ( \frac{ρ {C}_{T}}{{A}_{1}} - \frac{ρ {C}_{T}}{{A}_{2}} ) Δ Q$$

in which A₂ is the cross sectional area of the reduced diameter portion (D₂) of the pipe.

At 43B, measured pressure in the pipe may continue to decrease, however the rate of pressure decrease may be different (e.g., larger) than in the part of the pressure curve at 43A because of increased friction effect in the smaller diameter part (D₂) of the pipe. The rate of pressure change at 43B is related to:

$$\frac{ρ {f}_{2}}{{D}_{2}^{5}}$$

in which f₂ is the friction coefficient in the smaller diameter (D₂) part of the pipe.

The reflected tube wave is observable as a pressure increase at 44, after which pressure may continue to increase at 45 for the same reasons as explained with reference to FIGS. 2 and 3.

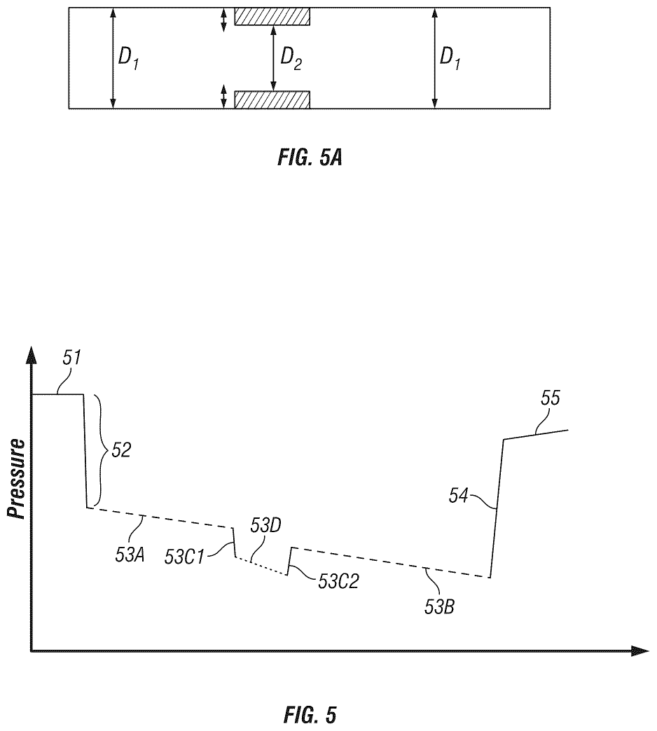

FIG. 5A shows another example in which pipe internal diameter may be reduced, e.g., by scale buildup from the nominal internal diameter D₁ to a smaller diameter D₂, but along a segment intermediate to the ends of the pipe. Referring to FIG. 5, measured fluid pressure in the pipe may include, at 51, 52, 54 and 55, responses resulting from change of the flow rate from Q1 to Q2 corresponding to the pressure responses explained with reference to 41, 42, 44 and 45 in FIG. 4.

In FIG. 5, the time interval between the flow rate change induced pressure drop at 52 and the reflected tube wave response at 54, i.e., the pressure decay, may have several distinct features related to the diameter changes shown in FIG. 5A. At 53A, pressure continues to decrease at a rate corresponding to friction in the larger diameter section (D₁) of the pipe. Rate of pressure decrease is related to:

$$\frac{ρ {f}_{1}}{{D}_{1}^{5}}$$

for the same reasons as explained with reference to FIG. 4. Correspondingly, at 53C1, an abrupt pressure drop may occur as a result of the tube wave impacting the onset of diameter reduction to D₂. The magnitude of the pressure drop is related in essentially the same way as explained with reference to FIG. 4:

$$Δ p = ( \frac{ρ {C}_{T}}{{A}_{1}} - \frac{ρ {C}_{T}}{{A}_{2}} ) Δ Q$$

At 53D, fluid pressure in the pipe decreases at a larger rate as a result of increased fluid friction in the smaller diameter portion of the pipe similarly as explained with reference to FIG. 4:

$$\frac{ρ {f}_{2}}{{D}_{2}^{5}}$$

At 53C2, the pipe internal diameter may return to nominal (or some other intermediate diameter), for example, by reason of the end of scale buildup. Such diameter change may be accompanied by an abrupt increase in pressure, substantially the reverse of the pressure decreases at 53C1. After such time, at 53B. the fluid pressure will decrease, but at a smaller rate. If the internal diameter of the pipe returns to nominal and there is no increase in surface roughness, that is, the friction coefficient is the same as in that part of the pipe before the diameter reduction, then the pressure decrease will return to the pre-scale rate at 53A.

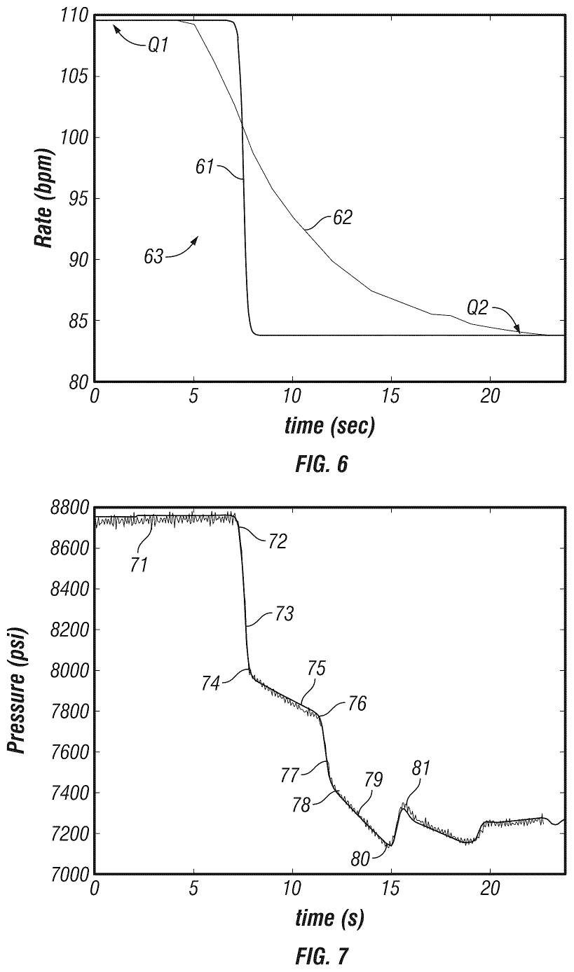

FIGS. 6 and 7 provide an illustrative example of pressure response to a flow rate change in a subsurface well in which there is diameter reduction caused by scale buildup and consequent internal diameter reduction. Although this example shows, and the discussion refers to a well, substantially the same pressure behavior will be apparent in a pipeline or other pipe or conduit with similar features. The illustrated example represents a well having a casing (inserted pipe) extending from the surface to a depth of 6,900 feet (2,103 m). The nominal internal diameter of the casing is 6.1 inches (15.5 cm). Internal diameter in the well from 6,900 feet to a total well depth of 21,000 feet (6,401 m) is reduced to 4.67 inches (11.9 cm). This mimics the effect of an abrupt occurrence of scale below 6,900 feet, which scale has a thickness of ~0.7 inches, well within the range of the examples explained with reference to FIGS. 4 and 5.

For the illustrated example, FIG. 6 shows a graph of fluid flow rate 61 and measured pressure 62 with respect to time. The flow rate is changed at 63 from a first flow rate Q1 to, in this example, a lower flow rate Q2. Measured pressure at 62 is sampled at a rate smaller than the time scale of certain responses in the pressure caused by features in the well. Such pressure responses may be observed in more detail in FIG. 7, which shows measured pressure in the well sampled at a higher rate, wherein such pressure responses are detectable. Thus, it is important for purposes of the present disclosure to sample pressure measurements at a high enough rate to detect certain responses in the pressure measurements that would be obscured if the pressure measurements were sampled at an insufficient rate. If the flow rate is measured, it is only necessary to sample such measurements at a rate sufficient to characterize the change in flow rate from the first rate Q1 to the second, lower rate Q2.

At 71, the measured pressure remains steady at the first fluid flow rate Q1. At 72, the fluid flow is changed from Q1 to Q2. At 73, the pressure change (drop) is attributable to the flow rate change from Q1 to Q2. 74 represents the time at which the fluid flow rate reached Q2. 75 illustrates pressure decay, i.e., the period during which pressure continues to drop as water hammer propagates down the well in the nominal diameter section, due to pipe friction.

76 represents the time at which the onset of the pressure pulse (tube wave), arrives at the measurement point due to a reflection from the proximate end (top of) the reduced diameter section; the travel time of the reflected tube wave is the time at 76 less the time at 72. Such travel time may be used to determine axial position along the well or pipe of the diameter reduction. The position can be computed as

$$L = {C}_{T} \frac{( {T}_{76} - {T}_{72} )}{2} ,$$

where C_{T} is the tube wave velocity.

Reference numeral 77 shows continued pressure drop of the reflection from the diameter change after the onset of scale buildup.

Reference numeral 78 shows the time at which the endpoint of the pressure drop, corresponding to 74, reaches the pressure measurement point as a reflected tube wave. After correcting time difference T₇₇−T₇₆ for pulse spreading due to fluid to pipe friction effects, the ratio (T₇₇−T₇₆)/(T₇₄−T₇₂) contains information about the reflector (abrupt vs. distributed diameter change).

Reference numeral 79 shows the time period during which pressure drops due to friction in the section of the well below the reflector.

Reference numeral 80 shows the onset of reflection of the pressure drop from the “end” of the well.

Reference numeral 81 shows the time at which the endpoint of the reflected tube wave reaches the pressure sensor. The characteristics of the pressure signal at 78, 79 and 80 may be used to provide detailed information about the characteristics of the tube wave reflector at the bottom of the well; however, such characteristics are not necessary in order to perform a method according to the present disclosure.

A method as explained above may be performed (repeated) at different times in order to characterize changes in pipe flow characteristics, e.g., buildup of scale or increased surface roughness, over time.

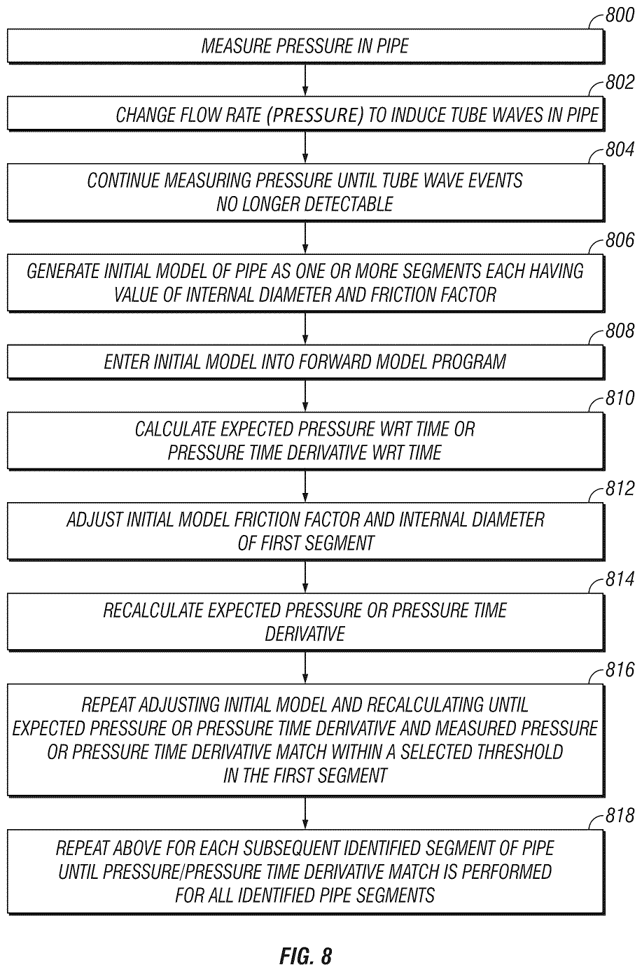

Referring to FIG. 8, in example implementations of a method according to the present disclosure, an inversion process may be used to determine lengths and friction factors of one or more segments of pipe each having different values of internal diameter and friction factor. The inversion process may use forward modelling to simulate pressure with respect to time at a selected location along the pipe (e.g., the measurement point) with reference to a change in flow rate or change in pressure of fluid flowing in the pipe. Forward modelling may be performed, e.g., using a simulation as explained in, Dunham, E. M., J. Zhang, D. Moos (2023), Constraints on pipe friction and perforation cluster efficiency from water hammer analysis, SPE-212337-MS, Paper presented at the SPE Hydraulic Fracturing Technology Conference and Exhibition, The Woodlands, Texas, USA, doi: 10.2118/212337-MS.

Pressure may be measured at the selected location along the pipe, shown at 800. At 802, a change in the flow rate of fluid may be imparted, e.g., by closing a valve or opening a valve to induce a change in pressure in the pipe of enough amplitude and short enough duration to induce tube waves in the pipe.

At 804 pressure measurement may continue until reflected tube wave events in the pipe are no longer detectable in the measured pressure. The foregoing may be determined, for example, by setting a pressure change (amplitude) threshold or below which any changes in pressure are not used.

An initial model of the pipe may be generated at 806. The initial model may comprise one or more segments of the pipe each having a length, internal diameter and friction factor. The initial model should at least include the segment of pipe closest to the measurement point. The initial model may form input to the forward model. Output of the forward model comprises a representation of expected pressure in the pipe at the measurement point with reference to time. Parameters in the initial model may comprise length of at least one segment of pipe, an estimate of the internal diameter of the at least one segment of pipe, and an estimate of the friction factor of the at least one segment of pipe. In some embodiments, the initial model may be constrained, for example, by a priori knowledge of the nominal internal diameter of the pipe proximate the measurement point.

At 808, the initial model is entered into the forward model and at 810 an expected pressure with respect to time is calculated. The calculated pressure is compared to the measured pressure. At 812, the initial model is adjusted by changing the internal diameter and friction factor, and at 814 the adjusted initial model is entered into the forward model and the expected pressure with respect to time is recalculated. At 816, the foregoing adjustment of the initial model, calculating expected pressure with respect to time and comparing the expected pressure to the measured pressure are repeated until differences between the expected pressure and the measured pressure are minimized or fall below a selected threshold.

As explained above, there may be observed in the measured pressure that additional segments exist in the pipe further from the measurement point having different flow properties, e.g., internal diameter and friction factor. At 818, for each such additional segment identified in the pressure measurements, the foregoing inversion process from 806 through 816 in FIG. 8 may be repeated until the measured pressure matches the expected pressure for all identified segments in or along the pipe.

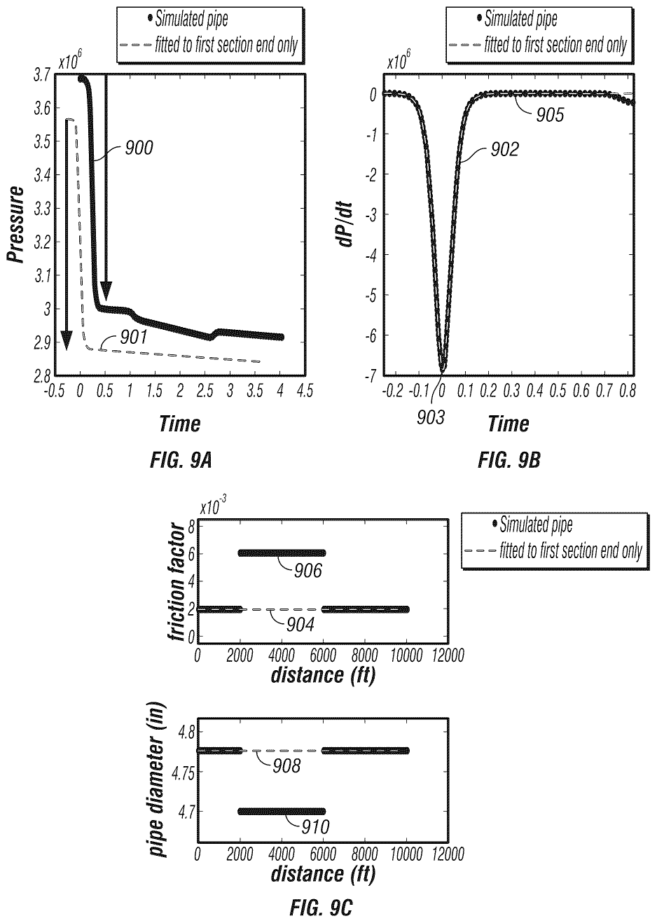

In some embodiments, rather than modeling pressure, pressure time derivative (dp/dt) may be modeled. A time derivative of the measured pressure may also be calculated in order to perform the inversion process described with reference to FIG. 8. Using pressure time derivative may facilitate determining the timing of specific events in the pressure data as well as their amplitude, e.g., the point in time at which tube waves may originate from a flow rate and consequent pressure change. Referring to FIG. 9A, measured pressure in a pipe before and after a flow rate change is shown at 900. Expected pressure calculated using the forward model is shown at 901. An initial value of friction factor, which may be constant over the entire length of pipe or the relevant segment of the pipe, is entered into the forward model. An initial value of pipe internal diameter entered into the forward model is shown in FIG. 9C at 904. FIG. 9B shows the pressure measurements from FIG. 9A converted into time derivative form at 902. The time at which the flow rate change may be presumed to generate tube waves is shown at trough 903. Numeral 905 shows the pressure time derivative after the pressure stops dropping as a result of the flow rate change, wherein continued pressure change (indicated by the value of dp/dt being slightly negative) indicates frictional pressure loss in the reflected tube wave event. When the values of pipe diameter and friction factor are correct for the first segment, the dp/dt curve as calculated by the forward model will match the dp/dt curve calculated from the measured pressure, at least to the end of the first pipe segment.

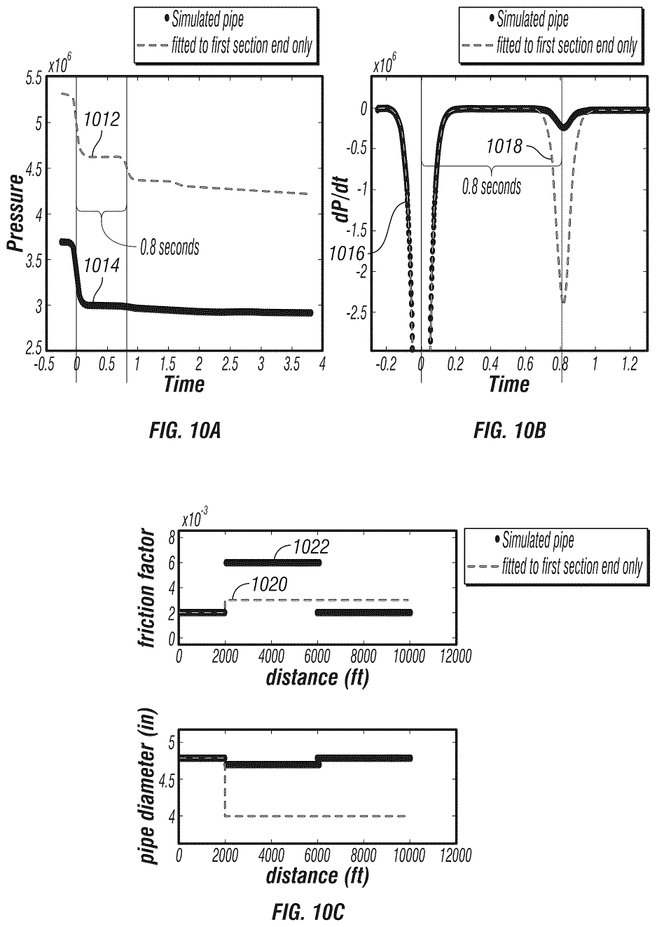

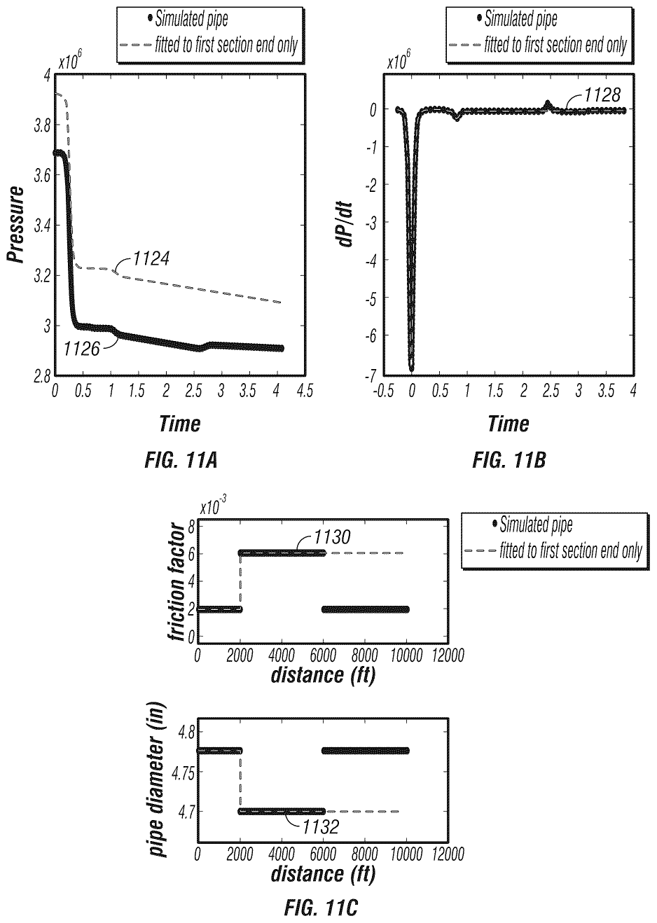

FIG. 10A shows measured pressure 1014 and modeled pressure 1012 pressure wherein at least a second pipe segment is identifiable in the pressure measurements by reason of having different fluid flow properties than the first segment. Corresponding dp/dt curves are shown in FIG. 10B, wherein a time at which the second pipe segment event occurs is correct, but the amplitude of the second event is incorrect. FIG. 10C shows the model pipe properties (e.g., internal diameter) and the actual pipe diameter at 1020 and 1022, respectively. Modeled and actual pipe friction factors are also shown. Diameter and friction factor are both the same in the first segment for the model and the actual pipe, but the model and actual pipe friction factor and diameter values are different in the second segment. The position of the junction between segments is correct (FIG. 10C), and the time of the reflection from the end of the first segment is correct (FIGS. 10A and 10B). FIG. 11A shows similar pipe pressure data at 1126 and 1124, wherein differences between pipe properties (e.g., internal diameter) shown in FIG. 11C are different than those shown in FIG. 10C. FIG. 11B shows that the timing and amplitude of the events in the dp/dt data match between forward model and measured pressure, wherein it may be inferred that the pipe properties (diameter and friction factor) are correctly determined.

In some embodiments, lookup tables of properties that may be measured in a pipe may be precalculated, using as input, known values of initial flow rate, final flow rate after a flow rate change, the fluid properties, and a range of pipe diameters and a range of friction factors.

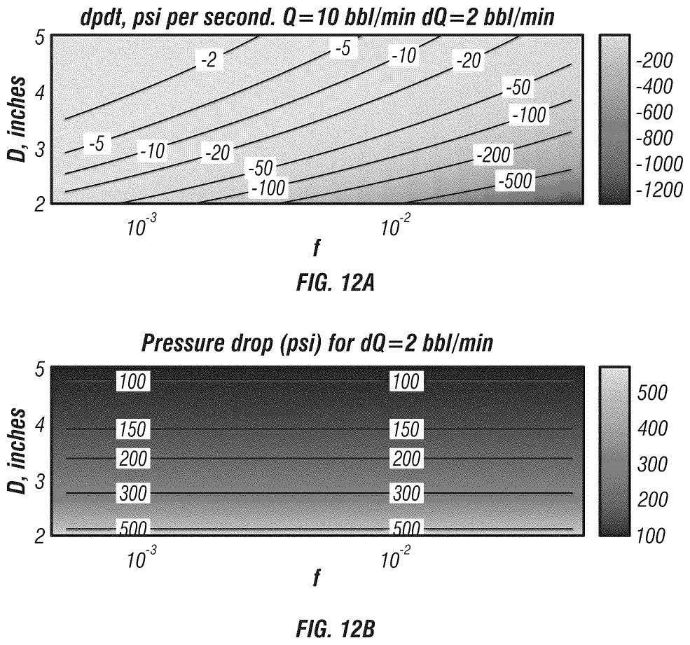

FIG. 12A shows a graph (nomogram) of such precalculated values. For FIG. 12A, a range of pipe diameters may be 2 to 5 inches (50 mm to 125 mm), and the range of f values is between 0.0005 and 0.05. The initial flow rate is 10 bbls/min. A flow rate change of 2 bbls/min is imposed on the flowing fluid. The contours in FIG. 12A define values of pressure decay, see, e.g., 905 in FIG. 9B after the initial pressure drop caused by the flow rate changes; the pressure decay has units of psi/second. The values in FIG. 12A may be calculated using known input values of the initial flow rate, flow rate change and fluid properties. The foregoing parameters may be entered into a forward model as described above, and using a range of values of pipe diameter D, and friction factor f, pressure decay rates corresponding to those values may be calculated and stored in the lookup table.

To use the lookup table, measurements of flow rate, flow rate change, pressure drop and pressure decay may be made in the pipe being analyzed. The pressure decay may be determined from pressure measurements made in the pipe after the flow rate change pressure drop has stabilized. If the value of pipe diameter is known or is determined, then the intersection of the pipe diameter and the pressure decay contour will provide the friction factor f on the coordinate scale of the nomogram. It will be appreciated that machine or computer calculation of f may be performed using the values of pressure drop and pressure decay measured within the pipe.

FIG. 12B shows that in general, the internal diameter of the pipe calculated from the pressure drop caused by flow rate change is substantially unaffected by the friction factor. Thus, a value of pipe diameter D may be determined using only the flow rate change and the pressure drop. Contour lines in FIG. 12B are scaled in pressure drop caused by the flow rate change (e.g., 2 bbls/min). The determined value of D may be entered into the graph in FIG. 12A to determine friction factor f based on the determined pressure decay.

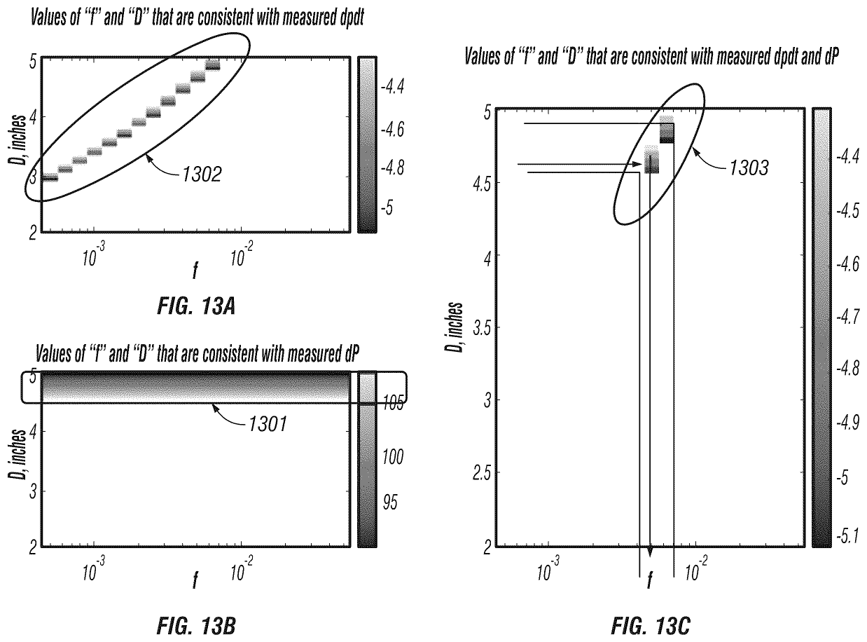

It will be appreciated that values of pressure decay and pressure drop may be subject to uncertainties, that is, the measured values may differ from the actual values to some extent depending on the placement and accuracy of the devices used to measure pressure, among other factors. Referring to FIG. 13A, the pressure decay may be subject to uncertainty that is graphically represented at 1302 by a “band” between pressure decay contours as shown in FIG. 12A. In FIG. 13B, pressure drop uncertainty, at 1301, provides uncertainty, shown as a band, in the determination of the pipe diameter. In FIG. 13C at 1303, the intersection of the pressure decay band (1302 in FIG. 13A) and the diameter band (1301 in FIG. 13B) results in an area 1303 that defines the likely bounds of pipe diameter and friction factor. While the solution is shown graphically in FIGS. 13A, 13B and 13C, it will be appreciated that the foregoing may be machine implemented in the form of lookup tables.

For measured values of pressure drop, flow rate, flow rate change and pressure decay that occur intermediate explicitly calculated values in the lookup tables, any suitable form of interpolation between the nearest explicitly calculated values may be used to generate final values for pipe diameter and friction factor.

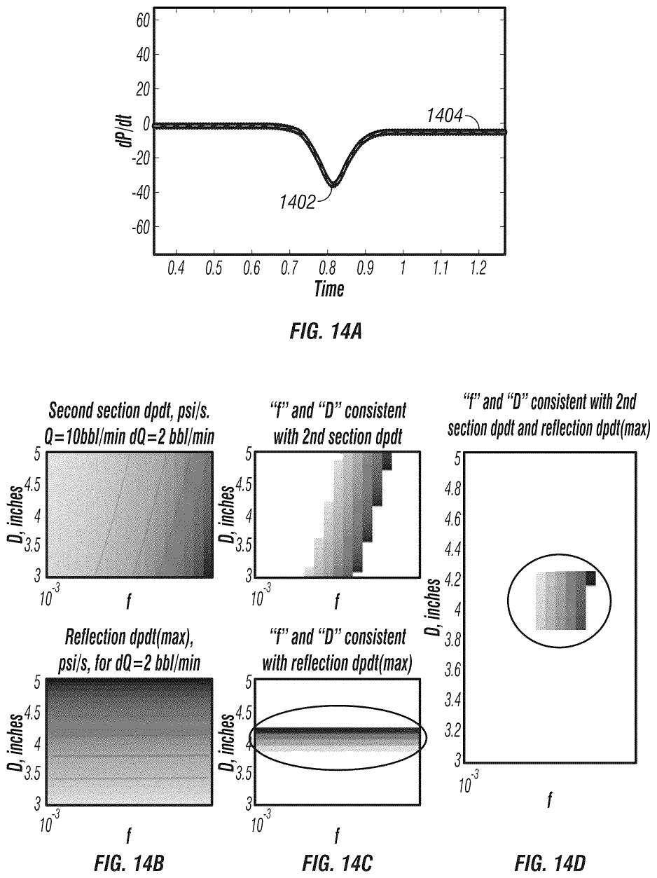

FIGS. 14A through 14D show using a maximum value of the time derivative of measured pressure dp/dt(max) during the flow rate change and the following pressure decay. This same approach may be used to determine the properties of a subsequent section of pipe if the flow properties (D, f) of the previous sections are known. FIG. 14A shows a reflected tube wave pressure change event after a flow rate change. A maximum (or minimum) value of dp/dt corresponds to the amplitude of the reflected tube wave event as shown at 1402. Pressure decay is indicated by a non-zero value of dp/dt following the reflected tube wave event at 1404.

A nomogram or lookup table process may be used to determine properties across a change in flow properties at a junction between two sections of pipe. Because the results depend on properties of other sections of the pipe different from those of the section whose properties are being determined, it is likely to be impractical to compute nomograms prior to determining those properties. However, there is still an advantage in being able to use uncertainty in the measurements to estimate uncertainty in the determined properties.

The present technique uses dp/dt(max) rather than pressure drop at the junction and pressure decay along the next section following the junction. Whereas using pressure drop as described above avoids needing to know the shape of the rate drop, however, using dp/dt(max) provides a more precise value with potentially lower uncertainty.

In an example embodiment first determine, for a tube wave reflection from a junction between sections with different properties using dp/dt; the maximum value during the reflection event and the value following that due to frictional pressure losses (pressure decay); see 1402 and 1404 in FIG. 14A.

A lookup table may be computed as shown graphically in FIGS. 14B and 14C, wherein the values of dp/dt during pressure decay correspond to various combinations of f and D and the values of maximum slope of the pressure drop (dp/dt(max)) correspond also to the same range of known values of f and D. The pre-computed predictions of dp/dt and dp/dt(max) are shown in FIGS. 14B and 14C, along with contours of constant dp/dt and dp/dt(max). Note that dp/dt(max) is independent of f whereas variations in f require changes in D to cause the same dp/dt. The intersection of lines corresponding to the measured dp/dt(max) and dp/dt thus are unique points in the D, f space and can be determined graphically or via the lookup table from a range of simulations. Contours in the lower plots are constant values of dp/dt(max). A reasonable range of f is from 1E-3 to 1E-2; in this case an evenly spaced set of log(f) i.e., −3<log(f)<−2 by 0.05 was chosen. Contours in the upper plots represent constant values of dp/dt in psi/s for the same range of values of f.

FIG. 14C shows the ranges of dp/dt and dp/dt(max) of the changes in pipe flow properties that are consistent with what is shown in FIG. 14A, for which the measured dp/dt is −5.3 psi/s and the measured dp/dt(max) of the change is −36. An uncertainty is chosen to be +/−10% of the measured value for illustration purposes. The intersection of these ranges is shown in FIG. 14D. corresponding to the range of values of f and D that would lead to the measured results, given the stated uncertainties. The actual values are within the ranges of 3.8<D<4.2 and 0.002<f<0.005. A method for detecting changes in pipe fluid flow properties, caused by, e.g., scale buildup or increases in surface roughness in pipes, such as subsurface wells or pipelines, may be performed without the need to stop production or movement of fluid along the pipe, and without the need to install specialized equipment other than one or more pressure sensors. In many instances, equipment to change flow rate of fluid will already be present at the well or pipeline and may be used in accordance with the present disclosure.

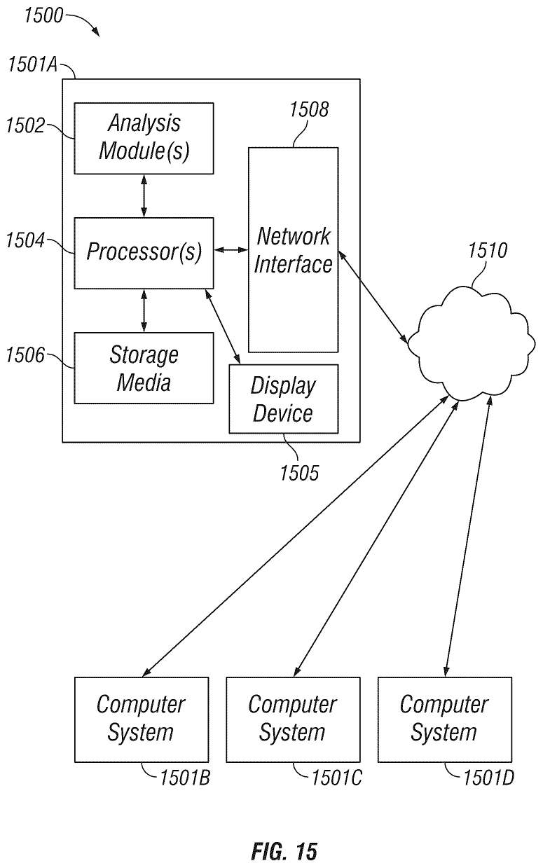

FIG. 15 shows an example computing system 1500 in accordance with some embodiments that may be used to implement a method according to the present disclosure. The computing system 1500 may be an individual computer system 1501A or an arrangement of distributed computer systems. The individual computer system 1501A may include one or more analysis modules 1502 that may be configured to perform various tasks according to some embodiments, such as the tasks explained with reference to FIG. 15. To perform these various tasks, the analysis module 1502 may operate independently or in coordination with one or more processors 1504, which may be connected to one or more storage media 1506. A display device 1505 such as a graphic user interface of any known type may be in signal communication with the processor 1504 to enable user entry of commands and/or data and to display results of execution of a set of instructions according to the present disclosure.

The processor(s) 1504 may also be connected to a network interface 1508 to allow the individual computer system 1501A to communicate over a data network 1510 with one or more additional individual computer systems and/or computing systems, such as 1501B, 1501C, and/or 1501D. Note that computer systems 1501B, 1501C and/or 1501D may or may not share the same architecture as computer system 1501A, and may be located in different physical locations, for example, computer systems 1501A and 1501B may be at a well drilling location, while in communication with one or more computer systems such as 1501C and/or 1501D that may be located in one or more data centers on shore, aboard ships, and/or located in varying countries on different continents.

A processor may include, without limitation, a microprocessor, microcontroller, processor module or subsystem, programmable integrated circuit, programmable gate array, or another control or computing device.

The storage media 1506 may be implemented as one or more computer-readable or machine-readable storage media. Note that while in the example embodiment of FIG. 15 the storage media 1506 are shown as being disposed within the individual computer system 1501A, in some embodiments, the storage media 1506 may be distributed within and/or across multiple internal and/or external enclosures of the individual computing system 1501A and/or additional computing systems, e.g., 1501B, 1501C, 1501D. Storage media 1506 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 1500 is only one example of a computing system, and that any other embodiment of a computing system may have more or fewer components than shown, may combine additional components not shown in the example embodiment of FIG. 15, and/or the computing system 1500 may have a different configuration or arrangement of the components shown in FIG. 15. The various components shown in FIG. 15 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A method for characterizing fluid flow properties in a pipe, comprising:
measuring pressure of a fluid flowing in the pipe;
changing a pressure of the fluid in the pipe from a first pressure to a second pressure, the changing pressure performed so as to induce tube waves in the pipe;
determining location along the pipe of and at least one of (i) magnitude of changes in internal diameter in the pipe or (ii) fluid flow friction factor of the pipe;
wherein the location is determined from measurements of a time between performing the pressure change and detection of a tube wave reflection caused by a change in the internal diameter; and
wherein the magnitude or friction factor are determined from a rate of change of the measured pressure with respect to time between the changing the pressure and a responsive pressure change caused by a tube wave reflection in the pipe.

2. The method of claim 1 wherein the pressure change is caused by changing a flow rate of fluid in the pipe from a first flow rate to a second flow rate.

3. The method of claim 1 wherein the rate of change of the measured pressure is determined from a value of a time derivative of the measured pressure.

4. The method of claim 1 wherein the time between performing the pressure change and detection of the tube wave reflection caused by a change in the internal diameter is determined by determining an elapsed time between successive peak or trough values in a time derivative of the measured pressure.

5. The method of claim 1 further comprising, at at least one selected time, repeating the measuring pressure of the flowing fluid, repeating changing the pressure the first pressure to the second pressure and determining location along the pipe and magnitude to characterize changes in the location and magnitude with respect to time.

6. The method of claim 1 wherein the determining location along the pipe of and at least one of (i) magnitude of changes in internal diameter in the pipe, or (ii) fluid flow friction factor of the pipe from tube wave induced events comprises inversion processing the measured pressure.

7. The method of claim 6 wherein the inversion processing is performed with respect to a time derivative of the measured pressure.

8. The method of claim 1 wherein the pipe diameter and the friction factor are determined from precalculated lookup tables generated using known values of flow rate, flow rate change, pressure change and pressure decay after the pressure drop.

9. The method of claim 8 wherein the precalculated lookup tables comprise parameter bands related to uncertainty in determining pressure decay and pressure change.

10. A non-transitory computer readable medium having stored thereon logic operable to cause a programmable computer to perform actions comprising:
accepting as input to the computer measurements of pressure of a fluid flowing in the pipe;
continuing to accept measurement of pressure in the pipe after changing a pressure of the fluid in the pipe from a first pressure to a second pressure, the changing pressure performed so as to induce tube waves in the pipe;
determining location along the pipe of and at least one of (i) magnitude of changes in internal diameter in the pipe, or (ii) fluid flow friction factor of the pipe;
wherein the location is determined from measurements of a time between performing the pressure change and detection of a tube wave reflection caused by a change in the internal diameter; and
wherein the magnitude or friction factor are determined from a rate of change of the measured pressure with respect to time between the changing the pressure and a responsive pressure change caused by a tube wave reflection in the pipe.

11. The computer readable medium of claim 10 wherein the changing pressure comprises changing a flow rate of fluid in the pipe from a first flow rate to a second flow rate.

12. The computer readable medium of claim 10 wherein the rate of change of the measured pressure is determined from a value of a time derivative of the measured pressure.

13. The computer readable medium of claim 12 wherein the time between performing the pressure change and detection of the tube wave reflection caused by a change in the internal diameter is determined by determining an elapsed time between successive peak or trough values in a time derivative of the measured pressure.

14. The computer readable medium of claim 10 further comprising logic operable to cause the computer to, at at least one selected time, repeating the accepting as input measured pressure of the flowing fluid, repeating changing the pressure from the first pressure to the second pressure and determining location along the pipe and magnitude to characterize changes in the location and magnitude with respect to time.

15. The computer readable medium of claim 10 wherein the determining location along the pipe of and at least one of (i) magnitude of changes in internal diameter in the pipe, or (ii) fluid flow friction factor of the pipe from tube wave induced events comprises inversion processing the measured pressure.

16. The computer readable medium of claim 15 wherein the inversion processing is performed with respect to a time derivative of the measured pressure.

17. The computer readable medium of claim 10 wherein the pipe diameter and friction factor are determined from precalculated lookup tables generated using known values of flow rate, flow rate change, pressure change and pressure decay after the pressure drop.

18. The computer readable medium of claim 10 wherein the precalculated lookup tables comprise parameter bands related to uncertainty in determining pressure decay and pressure change.
